(19) United States
(12) Patent Application Publication
(10) Pub. No.: US 2026/0228059 A1
(43) Pub. Date: Aug. 6, 2026

(54) CENTRALIZED MANAGEMENT OF API COMMUNICATIONS ACROSS FEDERATED CONTROLLERS

(71) Applicant: Cisco Technology, Inc., San Jose, CA (US)

(72) Inventors: Vijay Sekhar Reddy, Foster City, CA (US); Ramesh Nethi, Bangalore (IN); Ankur Bhargava, Pleasanton, CA (US); Elango Ganesan, San Jose, CA (US); Prashanth Patil, San Jose, CA (US); Aniruddh S Dikhit, San Jose, CA (US); Abhilash Sreedharan Nair Mannathanil, Dublin, CA (US); Iain Maclachlan Hamilton, Kilcreggan (GB)

(21) Appl. No.: 19/047,266

(22) Filed: Feb. 6, 2025

(51) Int. Cl. G06F 9/54

(52) U.S. Cl. CPC G06F 9/54

(57) ABSTRACT

Techniques for a centralized controller to manage API communications across heterogeneous, federated controllers. The centralized controller provides a unified interface for users to interact with multiple federated controllers. The centralized controller determines the types and/or versions of the federated controllers and identifies existing APIs used to communicate with the federated controllers. The centralized controller maintains an endpoint specification that maps APIs of the centralized controller to different APIs of the federated controllers. The centralized controller calls these different APIs to cause performance of operations requested by users on the federated controllers. The federated controllers return results of the operations to the centralized controller in various formats that are specific to the different federated controllers. The centralized controller uses the endpoint specification to convert, and potentially aggregate, the data back into the centralized controller layer. The centralized controller can then centralized controller may present the final results to the users.

### TECHNICAL FIELD

The present disclosure relates generally to techniques for a centralized controller to federate Application Programming Interface (API) communications across heterogeneous network controllers.

### BACKGROUND

Software-Defined Networking (SDN) controllers are centralized software platforms that manage and control network devices and resources in various network architectures and domains. Controllers serve as the “brain” of the network, abstracting the underlying hardware and providing a programmatic interface for configuring, managing, and optimizing network operations. This centralization simplifies network management, increases agility, and improves scalability. Due to the usefulness of controllers, networking vendors have developed and offered various SDN controllers to help customers manage many different network domains (e.g., Security, SD-WAN, data center, enterprise, etc.).

However, utilizing many heterogenous controllers can present various challenges, such as interoperability issues caused by different protocols, lack of unified visibility across the controllers, policy coordination, and scalability coordination. These limitations hinder the ability of network administrators to effectively oversee and control their entire network infrastructure from a centralized point, leading to increased operational complexity and potential security vulnerabilities. For instance, in large-scale enterprise environments, current solutions often fail to provide a cohesive view of the network across different domains, forcing administrators to juggle multiple management interfaces. Another example is in multi-vendor network deployments, where existing methods are unable to seamlessly integrate and federate APIs from diverse controller platforms, resulting in fragmented network management and reduced operational efficiency.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a centralized controller manages API communications across heterogeneous, federated controllers.

FIG. 2 illustrates a component diagram of an example centralized controller.

FIG. 3 illustrates an example of portions of an endpoint specification.

FIGS. 4A and 4B collectively illustrate a sequence diagram of example communications for a centralized controller to manage API communications across federated controllers according to an asynchronous behavior.

FIGS. 5A and 5B collectively illustrate a sequence diagram of example communications for a centralized controller to manage API communications across federated controllers according to a synchronous behavior.

FIG. 6 illustrates an example of a centralized controller performing progressive rendering by progressively presenting data as API communications are received from federated controllers.

FIGS. 7A and 7B collectively illustrate a flow diagram of an example method for a centralized controller to manage API communications across heterogeneous, federated controllers.

FIG. 8 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to a centralized controller that federates API communications across heterogeneous, federated controllers.

The method may include enrolling the federated controllers with the centralized controller that provides a unified interface through which a user interacts with the federated controllers. Further, the method includes receiving, at the centralized controller, a request from the user to cause the federated controllers to perform an operation, and determining that the federated controllers include a first federated controller of a first controller type and a second federated controller of a second controller type. The method further includes mapping the request to a first API call that is supported by controllers of the first controller type that causes the first federated controller to perform the operation, and mapping the request to a second API call that is supported by controllers of the second controller type that causes the second federated controller to perform the operation, the second API call being different than the first API call. The method includes sending, from the centralized controller, the first API call to the first federated controller and the second API call to the second federated controller, and receiving, at the centralized controller, a first response including a first result of the operation performed by the first federated controller. Further, the method includes receiving, at the centralized controller, a second response including a second result of the operation performed by the second federated controller. The method further includes aggregating the first result and the second result into an aggregated result, and providing the user with access to the aggregated result.

Additionally, the techniques of the method, and any other techniques described herein, may be performed by a system and/or device having non-transitory computer-readable media storing computer-executable instructions that, when executed by one or more processors, performs the method(s) described above.

### Example Embodiments

This disclosure describes techniques for a centralized controller to manage API communications across heterogeneous, federated controllers. In some cases, the centralized controller may provide a unified interface for users to interact with multiple federated controllers. The centralized controller may determine the types and/or versions of the different federated controllers and identify existing APIs used to communicate with the controllers. The centralized controller may maintain an endpoint specification that maps APIs of the centralized controller to the different APIs of the federated controllers. For example, when a user utilizes a centralized controller API to request that an operation be performed by the federated controllers (e.g., collect log data), the endpoint specification may be used to convert or map that centralized controller API to the different APIs that exist for each of the federated controllers. The centralized controller may call these different APIs to cause performance of the request operation on the federated controllers. The federated controllers may return results of the operation (e.g., requested log data) to the centralized controller in various formats that are specific to the different federated controllers. In such examples, the centralized controller may use the endpoint specification to convert or adapt, and potentially aggregate, the data back into the centralized controller layer. Once the centralized controller has adapted and aggregated the different result data received from the federated controllers, the centralized controller may present the aggregated results to the user.

Furthermore, the techniques described herein include a progressive rendering capability that allows partial data to be displayed as it becomes available from different controllers. This approach maintains responsiveness even when dealing with controllers that have varying latencies or performance characteristics. The centralized controller also provides a user interface that dynamically updates to show the current status of data retrieval and allows user interaction with partial results before all controllers have responded, significantly enhancing the user experience and operational efficiency in managing complex, multi-domain network environments.

Users generally utilize various types of network controllers to manage different networking domains, such as data center controllers, SD-Access controllers, SD Wide Area Network (SD-WAN) controllers, wireless and switching controllers, security controllers, and enterprise or branch network controllers. These various controllers often have different APIs, and return data in different formats than each other. The centralized controller is configured to utilize existing APIs of the federated controllers to seamlessly communicate with the federated controllers without requiring changes on the federated controllers. To do so, the centralized controller utilizes a mechanism to federate API calls once invoked, get responses back from the different API calls, and not change anything on the federated controllers. With heterogenous controllers, and even with different versions of the same controllers, there will be disjoint APIs being called. Additionally, when the responses come back, the data contained therein will be in different formats and isolated data sets. The centralized controller utilizes the endpoint specification to try to adapt the data back to the centralized controller layer.

The centralized controller unifies management operations and visibility across a plurality of federated controllers. This centralized controller utilizes an endpoint specification for API federation, adaptation, and normalization, allowing it to interface with heterogeneous controllers without requiring massive data replication or state synchronization. The centralized controller dynamically extracts data from underlying federated controllers in real-time, adapting and displaying it in a unified manner.

To federate the heterogeneous (and homogenous controllers for instances of the same controller), users may initially request that the centralized controller unify the management of their disparate network controllers, and the federated controllers may perform techniques to register or enroll with the centralized controller. The centralized and federated controllers may establish trust such that the centralized controller is able to authenticate the identity of users once on behalf of all the federated controllers. The centralized controller may obtain access tokens for the different user identities from the federated controllers and pass the access tokens for the authenticated identities to the federated controllers with which the authenticated users wish to interact. The individual federated controllers use the access tokens and local access policies to locally authorize the users to determine if the users can perform certain operations or access certain resources. Accordingly, the centralized controller implements centralized authentication while allowing for distributed authorization by the federated controllers.

The users may begin using the unified interface provided by the centralized controller to request operations be performed on one or more of the federated controllers (e.g., cause network operations to be performed, request that data be pulled from the federated controllers, etc.). In some instances, the users may request that the same or similar operations be performed by a group or all of their federated controllers contemporaneously. For instance, a user may request, via the unified interface, that the federated controllers each provide data indicating the number of security events logged in their respective domains over the previous week. As another example, the user may request that all federated controllers with a particular configuration have an update or patch applied for that configuration.

Once users are authenticated, the centralized controller may generally behave as a communication proxy, such as an API proxy, and proxy communications and data between the users and federated controllers. The centralized controller utilizes the endpoint specification to determine the APIs used to communicate with the different federated controllers. Based on the operation request submitted by the users, the centralized controller may use the endpoint specification to map the centralized controller API called to the federated controller APIs to use when communicating the operation requests to the appropriate federated controllers. In addition to selecting the appropriate APIs, the centralized controller may select the appropriate access tokens for each federated controller that is usable by the respective federated controllers to determine a local identity of the user and perform authorization process(es) for the user based on their identity (e.g., use access policies to determine authorizations or permissions). The centralized controller may populate the appropriate APIs with the operation request information from the user and send the API calls along with the access tokens to the federated controllers.

In some examples, the users may further specify which retrieval protocol they would like to use for the federated API calls. A Representational State Transfer (REST) endpoint may be used to communicate the API calls to the federated controllers, and this REST endpoint is capable of responding in a synchronous, asynchronous, or streaming mode. In some instances, the user may select from among the API modes of synchronous, asynchronous, or streaming (WebSocket). In the synchronous mode, which may be the default behavior for the GET APIs, a single response is returned to the user once the responses are all processed from all the controllers. In the asynchronous mode, the user may receive responses for individual controllers as those results come in without waiting for the other controllers. In the streaming mode, the user may receive the data as it comes in for all of the controllers regardless of whether the controllers have received all of the data.

In the asynchronous and streaming modes, the centralized controller may enable a progressive rendering capability that allows partial data to be displayed as it becomes available from different controllers. This approach maintains responsiveness even when dealing with controllers that have varying latencies or performance characteristics. The centralized controller also provides a user interface that dynamically updates to show the current status of data retrieval and allows user interaction with partial results before all controllers have responded, significantly enhancing the user experience and operational efficiency in managing complex, multi-domain network environments.

When the data comes back to the centralized controller, the endpoint specification may be utilized to adapt and normalize the data to a common format. In some examples, depending on the APIs called, the endpoint specification may also be used to aggregate the data (e.g., 2 devices saying one hundred devices under each of them, so we tell them they are managing two hundred devices). Thus, for API calls that go to a single domain of controllers, there may be a simpler multiplex and demultiplex operations. However, multi-domain API calls developed for times and will have more difficult to just multiplex and demultiplex operations. The endpoint specification may comprise a plurality of rules and logic to understand how to normalize, and potentially aggregate, the data based on the different controller being called, different versions of the controllers be called, and the API calls that were invoked. This logic is contributable by defining the endpoint specification and what normalizers to invoke. Normalizers could be contributed if the use case demands a specific logic to be applied that the endpoint specification is not configured to apply.

The techniques described herein improve the functioning of distributed systems by centralizing the control for distributed, heterogenous controllers. Rather than having users interact with each individual federated controller (or other system or device), the techniques described herein allow for a centralized controller to communicate with the federated controllers simultaneously on behalf of the user, and present aggregated and unified results to the user.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

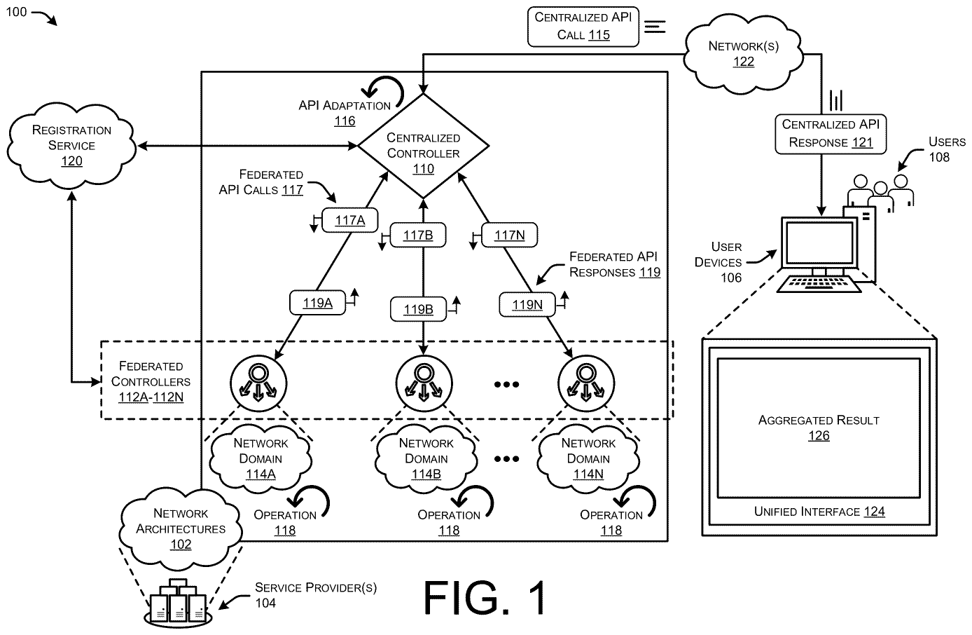

FIG. 1 illustrates a system-architecture diagram of an environment 100 in which a centralized controller manages API communications across heterogeneous, federated controllers.

The environment 100 may include one or more network architecture(s) that are managed or provided by one or more service providers 104 that provide networks and/or network services to users 108 via their user devices 106. The network architecture 102 may include a centralized controller 110 that communicates with and manages federated controllers 112A-112N. Generally, the centralized controller 110 is a centralized software platform that serves as a proxy and management platform through which users 108 can interact with their federated controllers 112 through a programmatic interface. The federated controllers 112 may each comprise any type of network controller, such as data center controllers, SDA controllers, SD-WAN controllers, wireless and switching controllers, security controllers, and enterprise or branch network controllers. the federated controllers 112 may each manage or control one or more respective network domain 114A, network domain 114B, and network domain 114N (where “N” is any integer greater than one as described herein). The network domains 114A-114N may similarly be any type of network domain, or network-related domain, which may be managed by controllers, such as data centers, SDA networks, SD-WAN networks, wireless and switching networks, security domains, and enterprise or branch networks.

The users 108 may register for and use the federated controllers 112 to manage their different network domains 114. According to the techniques described herein, the users 108 may access a portal, console, or other unified interface 124 of the centralized controller 110 to declare their desire to federate their controllers 112 under the centralized controller 110. The federated controllers 112 may host an agent that is capable of determining that the users 108 declared this desire, such as through an advertisement from the centralized controller 110 or through a registration service 120 that is trusted by all the controllers (e.g., cloud-based registration service). In some examples, the registration service 120 is used to orchestrate communications between the centralized controller 110 and the federated controllers 112. The federated controllers 112 reach out to the registration service 120 to discover information about the centralized controller 110, and obtain registration tokens from the registration service 120. The registration service 120 may determine that the federated controllers 112 are authentic controllers utilized by the user 108, and provide the registration tokens to the federated controllers 112. Similarly, the centralized controller 110 may communicate with the registration service 120 to obtain token validation details that are usable to validate the registration tokens provided to the federated controllers 112.

In some instances, the registration service 120 may be a cloud-based entity to facilitate secure communication and trust establishment between the centralized controller 110 and the federated network controllers 112. In some cases, the centralized controller 110 may advertise information to the cloud entity, including its public certificate and IP address. This information may be used to establish the centralized controller's 110 identity and enable secure communication channels. Federated controllers 112 may receive public information, certificate information, and signing details from the cloud entity. This information may allow the federated controllers 112 to verify the identity of the centralized controller 110 and establish secure connections. By obtaining this information from a trusted cloud entity (e.g., registration service 120), the techniques describe herein may reduce the risk of unauthorized access or impersonation attempts.

The centralized controller 110 and federated network controllers 112 may use a customized authentication mechanism similar to OAuth (or actually OAuth) for establishing initial trust. This mechanism may involve a series of token exchanges and validations, allowing the components to verify each other's identities and establish secure communication channels. The customized approach may be tailored to the specific needs of the network management system, providing enhanced security and flexibility.

For instance, the federated controllers 112 may then present their registration tokens to the centralized controller 110 to authenticate themselves as being deemed trustworthy by the registration service 120. The centralized controller 110 utilizes the token validation details to validate the registration tokens and enroll the federated controllers 112. After enrollment, the centralized controller 110 and federated controllers 112 may exchange credentials for bi-directional communication, such as OAuth credentials and API details (e.g., discovery API), JWT and TLS Certificates, centralized controller 110 endpoints, notifications, etc. Further, the each of the federated controllers 112 may provide respective access tokens that indicate identities for the users 108 that are registered with the federated controllers 112. The centralized controller 110 may then store or cache the access tokens for all of the federated controllers 112.

Once trust is established, the centralized controller 110 may handle user authentication, while the federated controllers 112 maintain control over authorization processes. This approach may allow for a streamlined user experience, with a single point of authentication, while preserving the ability of individual network domains 114 to enforce their specific access policies and security rules.

After enrollment and registration of the federated controllers 112 by the centralized controller 110, users may begin interfacing with all of the federated controllers 112 via a single, unified interface 124 (or “dashboard”, “console”, etc.) provided by the centralized controller 110. The user 108 may initially perform authentication with the centralized controller 110 using any type of authentication mechanism (e.g., password-based authentication, MFA, Biometric Authentication, Token-based Authentication, Certificate-based Authentication, Challenge-Response Authentication, Behavioral Authentication, etc.). The centralized controller 110 is then able to determine the identity of the user 108, and determine which access tokens belong to that user 108 for each of the federated controllers 112. In some instances, each network controller may be associated with its own separate access token. In other examples, the federated controllers 112 may include replicas or fleets of controllers of the same type that shared access tokens. The centralized controller 110 may store mappings between user identities, access tokens, and federated controllers 112.

The users 108 may begin using the unified interface provided by the centralized controller 110 to request operations be performed on one or more of the federated controllers 112 (e.g., cause network operations to be performed, request that data be pulled from the federated controllers 112, etc.). In some instances, the users 108 may request that the same or similar operations be performed by a group or all of their federated controllers 112 contemporaneously. For instance, a user 108 may request, via the unified interface 124, that the federated controllers 112 each provide data indicating the number of security events logged in their respective domains over the previous week. As another example, the user 108 may request that all federated controllers 112 with a particular configuration have an update or patch applied for that configuration.

Once users 108 are authenticated, the centralized controller 110 may generally behave as a communication proxy, such as an API proxy, and proxy communications and data between the users and federated controllers 112. The users 108 may submit centralized API calls 115 to the centralized controller 110 to cause the centralized controller to manage operations across the federated controllers 112. The centralized controller 110 may store an endpoint specification that maps centralized API calls 115 to the different APIs of the federated controllers 112. Using this endpoint specification, the centralized controller 110 may perform API adaptation 116 to convert these APIs. The centralized controller 110 may determine the types and/or versions of the different federated controllers 112 being called by the centralized API calls 115 from the users 108, and use the endpoint specification mappings to identify federated API call 117A, federated API call 117B, and federated call 117N used to communicate with the federated controllers 112 to perform the requested operations. Thus, the endpoint specification maintained by the centralized controller 110 may comprise mappings of the different centralized API calls 115 to the various federated API calls 117 of the federated controllers 112.

For example, when a user 108 utilizes a centralized API call 115 to request that an operation 118 be performed by the federated controllers 112 (e.g., collect log data), the endpoint specification may be used to convert or adapt that centralized API calls 115 to the different federated API calls 117 that exist for each of the federated controllers 112. The centralized controller 110 may call these different federated API calls 117 to cause performance of the request operation 118 on the federated controllers 112. The federated controllers 112 may perform the operation 118 and may return results of the operation (e.g., requested log data) to the centralized controller 110 using federated API response 119A, federated API response 119B, and federated API response 119N (collectively federated API responses 119).

When the federated controllers 112 are of different types and/or versions, the data returned in the federated API responses 119 may be in various formats that are specific to the different federated controllers 112. In such examples, the centralized controller 110 may use the endpoint specification to convert or adapt, and potentially aggregate, the data back into the centralized controller layer. Once the centralized controller 110 has adapted and aggregated the different result data received from the federated controllers 112, the centralized controller 110 may present the aggregated result 126 to the user 108.

In some examples, the network architecture(s) 102 may include devices housed or located in one or more data centers or other physical locations. The network architecture 102 may include one or more networks implemented by any viable communication technology, such as wired and/or wireless modalities and/or technologies. The network architecture 102 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed-and/or any combination, permutation, and/or aggregation thereof. The network architecture 102 may include devices, virtual resources, or other nodes that relay packets from one network segment to another by nodes in the computer network. The network architecture 102 may include multiple devices that utilize the network layer (and/or session layer, transport layer, etc.) in the OSI model for packet forwarding, and/or other layers. The network architecture 102 may include various hardware devices, such as routers, switches, gateways, smart NICs, NICs, ASICs, FPGAs, servers, and/or any other type of device. Further, the network architecture 102 may include virtual resources, such as VMs, containers, and/or other virtual resources.

The one or more data centers may be physical facilities or buildings located across geographic areas that designated to store networked devices that are part of the network architecture 102. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth).

The user devices 106 may establish communication connections over one or more networks 122 to communicate with devices in the network architecture 102, such as a centralized controller 110 of the network architecture 102. The network(s) 122 may include any viable communication technology, such as wired and/or wireless modalities and/or technologies. Networks 122 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed and/or any combination, permutation, and/or aggregation thereof. The user devices 106 may communicate using any type of protocol over the network 122, such as the transmission control protocol/Internet protocol (TCP/IP) that is used to govern connects to and over the Internet.

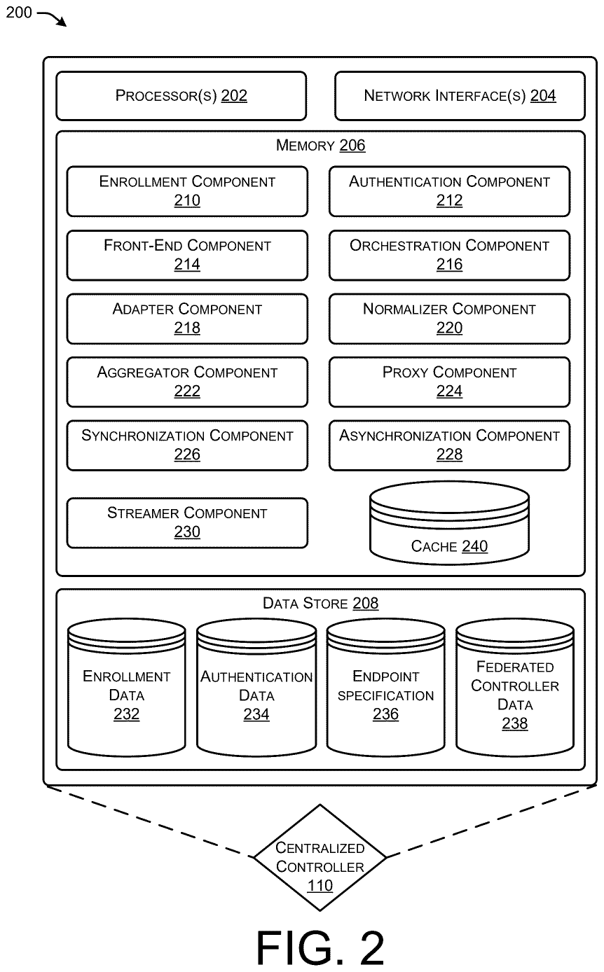

FIG. 2 illustrates a component diagram 200 of an example centralized controller 110. As illustrated, the centralized controller 110 may include one or more hardware processors 202 (processors), one or more devices, configured to execute one or more stored instructions. The processor(s) 202 may comprise one or more cores. Further, the centralized controller 110 may include one or more network interfaces 204 configured to provide communications between the centralized controller 110 and other devices, such as the federated controller 112, user devices 106, and/or other systems or devices in the network architecture 102 and/or remote from the network architecture 102. The network interfaces 204 may include devices configured to couple to personal area networks (PANs), wired and wireless local area networks (LANs), wired and wireless wide area networks (WANs), and so forth. For example, the network interfaces 204 may include devices compatible with Ethernet, Wi-Fi, and so forth.

The centralized controller 110 may also include memory 206, such as computer-readable media, which stores various executable components (e.g., software-based components, firmware-based components, etc.). The memory 206 may generally store components to implement functionality described herein. The memory 206 may store an operating system utilized to control the operation of components of the centralized controller 110. Further, the memory 206 may store a communication component that comprises software (e.g., any protocol stack) to enable the centralized controller 110 to communicate with other devices using the network interface 204. Even further, the memory 206 may store one or more applications, which may generally comprise any type of software application to perform various functionalities.

The memory 206 contains multiple functional components that work together to implement the functionality of the centralized controller 110. These components include an enrollment component 210, an authentication component 212, a frontend component 214, and an orchestration component 216. The memory 206 also includes an adapter component 218, a normalizer component 220, an aggregator component 222, and a proxy component 224. Additionally, the memory 206 contains a synchronization component 226, an asynchronization component 228, and a streamer component 230. A cache 240 is also present in the memory 206 for temporary data storage.

A data store 208 maintains several data repositories, including enrollment data 232, authentication data 234, an endpoint specification 236, and controller data 238. These repositories store persistent data used by the various components of the system.

The enrollment component 210 may handle the process of registering new federated controllers 112 with the centralized controller 110. The enrollment component 210 may manage the onboarding process, collecting necessary information about each federated controller 112, and storing it in the enrollment data 232 repository.

The authentication component 212 may be responsible for verifying the identity of federated controllers 112 and users 108 interacting with the centralized controller 110. The authentication component 212 may implement various authentication protocols and store authentication-related information in the authentication data 234 repository.

The frontend component 214 may provide the unified interface 124 for interacting with the centralized controller 110. This frontend component 214 may handle user input, display the aggregated results 126, and manage the overall user experience. The frontend component 214 may support different modes of data presentation, including synchronous, asynchronous, and streaming modes, to accommodate various use cases and network conditions.

The orchestration component 216 may coordinate the activities of other components within the centralized controller 110. The orchestration component 216 may manage the flow of requests and responses between the frontend component 214 and the various backend components responsible for interacting with federated controllers 110.

The adapter component 218 may be responsible for translating the centralized API calls 115 from the centralized controller 110 format to formats of the federated API calls 117 that are compatible with different types of federated controllers 112. This adapter component 218 may use the endpoint specification 236 to determine the appropriate API calls for each controller type.

The normalizer component 220 may process responses from federated controllers 112, converting them into a standardized format that can be used by other components of the centralized controller 110. This normalization process may ensure consistent data representation across different controller types and versions. The endpoint specification 236 may contain rules and logic for normalizing or converting the data into a common format. The aggregator component 222 may combine normalized responses from the federated controllers 112 into a unified result set. This aggregator component 222 may be responsible for merging data from different sources and resolving any conflicts or inconsistencies.

The proxy component 224 may act as an intermediary between the centralized controller 110 and the federated controllers 112, handling communication protocols and managing connections. The proxy component 224 may help abstract the complexities of interacting with diverse controller types.

The synchronization component 226 and asynchronization component 228 may support different modes of interaction with federated controllers 112. The synchronization component 226 may handle synchronous API calls, while the asynchronization component 228 may manage asynchronous operations. The streamer component 230 may facilitate streaming data transfers between the centralized controller 110 and federated controllers or client applications. The streamer component 230 may enable real-time data updates and progressive rendering of results. The cache 240 may provide temporary storage for frequently accessed data or intermediate results, improving the overall performance of the centralized controller 110.

In various embodiments, the centralized controller 110may support multiple modes of providing centralized API responses 121, including synchronous, asynchronous, and streaming modes. The synchronization component 226 may handle synchronous responses, where the centralized controller 110 waits for all federated controllers 112 to respond before returning a result to the user 108. The asynchronization component 228 may manage asynchronous responses, allowing the centralized controller 110 to return partial results as they become available from individual federated controllers 112. The streamer component 230 may enable streaming responses, providing a continuous flow of data updates to users 108 as information is received from federated controllers 112.

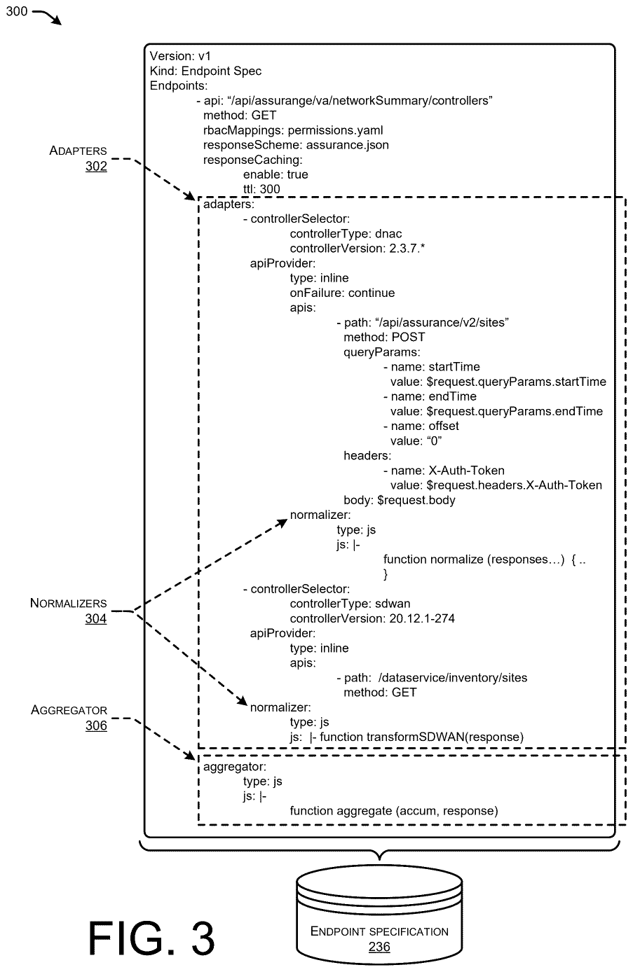

FIG. 3 illustrates a diagram 300 of example of portions of an endpoint specification 236 that processes API calls across federated controllers 112. The endpoint specification 236 defines the structure and parameters for API requests and responses. The endpoint specification 236 may store the configuration data that governs how API calls are processed.

As shown, the endpoint specification 236 may include a portion of code defining an example of adapters 302, a portion of code defining an example of normalizers 304, and a portion of code defining an example of an aggregator 306. The adapters 302 may handle the adaptation of API calls for different controller types, including specifications for controller selection, API paths, and request parameters. The adapters 302 portion may define different controller types and versions for the federated controllers 112 (e.g., DNAC version 2.3.7), and also the rules and logic for adapting the federated API calls 117 to the centralized API calls 115, and vice-versa.

The normalizers 304 portions may process and standardize responses from different federated controllers 112 using JavaScript-based normalization functions, in some examples. The aggregator 306 portions may be used to combine the normalized responses from federated controllers 112 into a unified format using JavaScript-based aggregation functions.

The portions the endpoint specification 236 may be utilized together to process API requests. The adapters 302 may first interpret the request according to controller-specific parameters, the normalizers 304 may then standardize the response, and finally, the aggregator 306 may combine the results into a unified response format.

The endpoint specification 236 may play a crucial role in enabling the centralized controller 110 to effectively manage and communicate with the federated controllers 112A-112N across different network domains. By providing a standardized way to handle API requests and responses, the endpoint specification 236 may allow for seamless integration of diverse network architectures 102 and controller types.

The endpoint specification 236 may serve as the central configuration point for defining how API requests should be processed across different controller types and versions. This endpoint specification 236 may contain rules and specifications that dictate how requests should be adapted, how responses should be normalized, and how data should be aggregated from multiple sources. In various embodiments, the endpoint specification 236 may be editable through a graphical user interface that allows network administrators to easily define and modify API specifications without requiring extensive programming knowledge. This may enable rapid adaptation to new controller types or API versions as they are introduced into the centralized controller 110.

The adapter 302 may employ machine learning algorithms to improve its ability to map centralized API calls to the appropriate federated API calls for each controller type. This may allow the system to automatically adapt to changes in API structures or new controller types over time. The normalizers 304 may support multiple normalization strategies, allowing it to handle a wide variety of response formats from different controllers. This may include the ability to parse and normalize both structured and unstructured data, enabling the system to work with legacy controllers that may not adhere to modern API standards.

The endpoint specification 236 may include error handling capabilities for various types of failures that may occur during the API federation process. These may include communication failures between the centralized controller 110 and the federated controllers 112A-112N, authentication failures when attempting to access protected API endpoints, authorization failures due to insufficient permissions, and timeout issues caused by slow-responding controllers. The error handling system may employ a retry mechanism with exponential backoff for communication failures, automatically attempting to re-establish connections with unresponsive controllers. This may improve the overall reliability of the centralized controller 110 in environments with unstable network connections. The error handling system may include detailed logging and reporting capabilities, providing network administrators with comprehensive information about any issues that occur during API federation. This may facilitate faster troubleshooting and resolution of problems within the environment 100. The error handling system may incorporate adaptive timeout settings that automatically adjust based on historical response times from each federated controller. This may help optimize the balance between waiting for slow controllers and maintaining overall system responsiveness.

The endpoint specification 236 may include a set of rules for normalizing and aggregating data based on different controller types and versions. These rules may define how data from disparate sources should be transformed into a consistent format that can be easily processed and displayed by the unified interface 124. In various embodiments, the normalization rules in the normalizers 304 may support complex data transformations, including field mapping, data type conversions, and unit standardization. This may allow the centralized controller 110 to present a coherent view of network data even when dealing with controllers that use different naming conventions or measurement units. The aggregation rules in the aggregator 306 may include support for various mathematical and statistical operations, enabling the system to perform real-time analysis of data from multiple controllers. This may allow network administrators to gain insights into overall network performance and trends across different domains. The normalization and aggregation rules may be dynamically updateable, allowing the system to adapt to changes in controller data formats or new reporting requirements without requiring a full system update. This may provide flexibility for the centralized controller 110 to evolve over time as network management needs change.

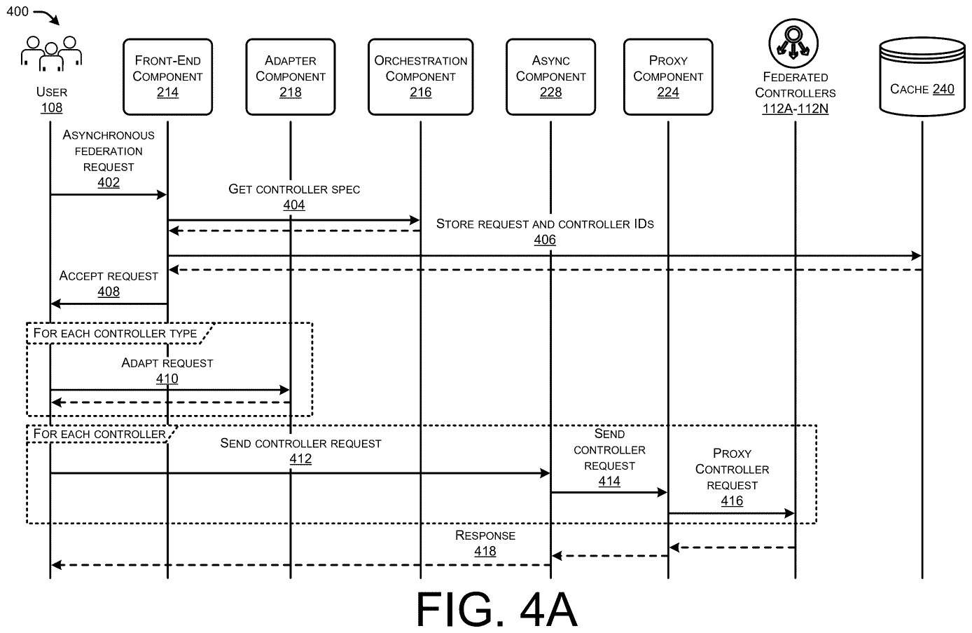

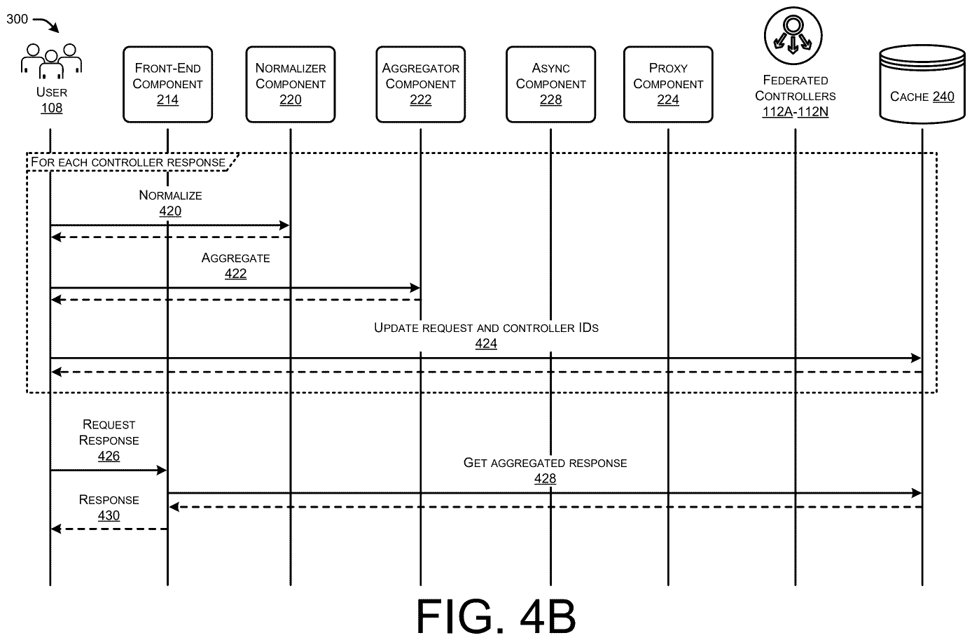

FIGS. 4A and 4B collectively illustrate a sequence diagram 400 of example communications for a centralized controller 110 to manage API communications across federated controllers 112 according to an asynchronous behavior, or asynchronous federation process, in accordance with one embodiment. As an option, the sequence diagram 400 may be implemented in the context of any one or more of the embodiments set forth in any previous and/or subsequent Figures and/or description thereof. Of course, however, the sequence diagram 400 may be implemented in the context of any desired environment. Further, the aforementioned definitions may equally apply to the description below. The sequence diagram 400 depicts interactions between various components of the environment 100, including the users 108, the frontend component 214, the orchestration component 216, the adapter component 218, the asynchronization component 228, the proxy component 224, the federated controllers 112A-112N, and the cache 240.

The asynchronous federation process begins with a step 402, where a user 108 initiates an asynchronous federation request to the frontend component 214. Upon receiving this request, the frontend component 214 proceeds to a step 404, sending a request to get the endpoint specification 236 to the orchestration component 216. In a step 406, the orchestration component 216 stores the request and controller IDs in the cache 240.

Following the storage of request information, a step 408 occurs where an accept request confirmation is sent back to the user 108. This step allows the system to acknowledge the user's request and begin processing without waiting for all controllers to respond.

The process then enters a step 410 that is performed for each type of federated controller 112 where the step 410 involves adapting the request for each specific controller type through the adapter component 218. This adaptation ensures that the request is properly formatted for each type of federated controller 112 in the system.

After the adaptation request is performed for each federated controller 112 type, steps are performed for each individual controller in a loop. This loop contains several steps that are executed for each individual controller. In a step 412, the frontend component 214 sends a controller request to the asynchronization component 228. The asynchronization component 228 then forwards this as a controller request in a step 414 to the proxy component 224. Finally, in a step 416, the proxy component 224 sends a proxy controller request to the federated controllers 112A-112N.

Step 418 represents the response being returned through the chain back to the frontend component 214 and ultimately the user 108.

FIG. 4B illustrates a continuation of the sequence diagram 400 showing the processing of controller responses in the asynchronous federation process, in accordance with one embodiment. As an option, the sequence diagram 400 may be implemented in the context of any one or more of the embodiments set forth in any previous and/or subsequent Figures and/or description thereof. Of course, however, the sequence diagram 400 may be implemented in the context of any desired environment. Further, the aforementioned definitions may equally apply to the description below.

The sequence continues with steps that are performed for each controller response received from the federated controllers 112A-112N. The process begins with a step 420, where the frontend component 214 initiates a normalize operation with the normalizer component 220. This step ensures that the data received from different controller types is standardized into a common format. Following normalization, a step 422 occurs where an aggregate operation is performed by the aggregator component 222. This step combines the normalized data from multiple controllers into a unified dataset. In a step 424, the system executes an update request and controller IDs operation, which spans across multiple components to the cache 240. This step ensures that the cache is updated with the latest information from the controllers.

After these processing steps, a step 426 is initiated from the frontend component 214, representing a request response operation. This is followed by a step 428, which is a get aggregated response operation that gets information from the cache 240. The sequence concludes with a step 430, where a response is returned to the user 108, providing the aggregated results of the asynchronous federation process.

In some examples, the frontend component 214 may use a streamer component 230 to handle both synchronous and asynchronous responses from the federated controllers 112A-112N. This streamer component 230 allows the frontend component 214 to process and display data as it becomes available, without waiting for all controllers to respond. In various embodiments, the streamer component 230 may implement a subscription-based model, where it subscribes to updates from each federated controller 112A-112N and pushes these updates to the frontend component 214 in real-time. In various embodiments, the asynchronous federation process may include error handling mechanisms within each step. These mechanisms may allow the system to gracefully handle timeouts, connection failures, or other issues that may occur when communicating with the federated controllers 112A-112N. In various embodiments, the cache 240 may implement a time-based expiration policy for stored requests and controller IDs. This policy may help manage memory usage and ensure that the cache contains only relevant, up-to-date information for ongoing asynchronous operations.

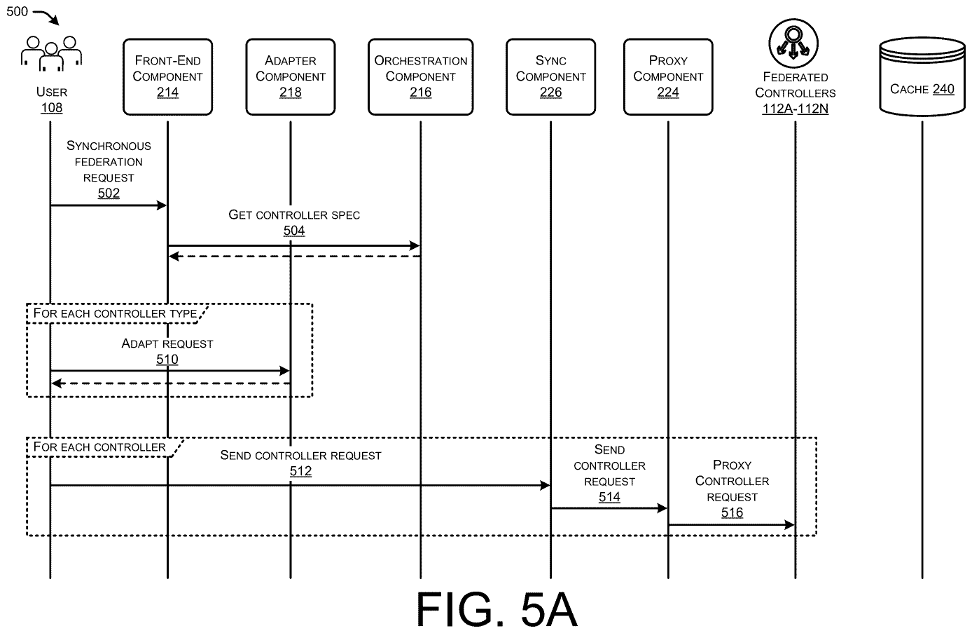

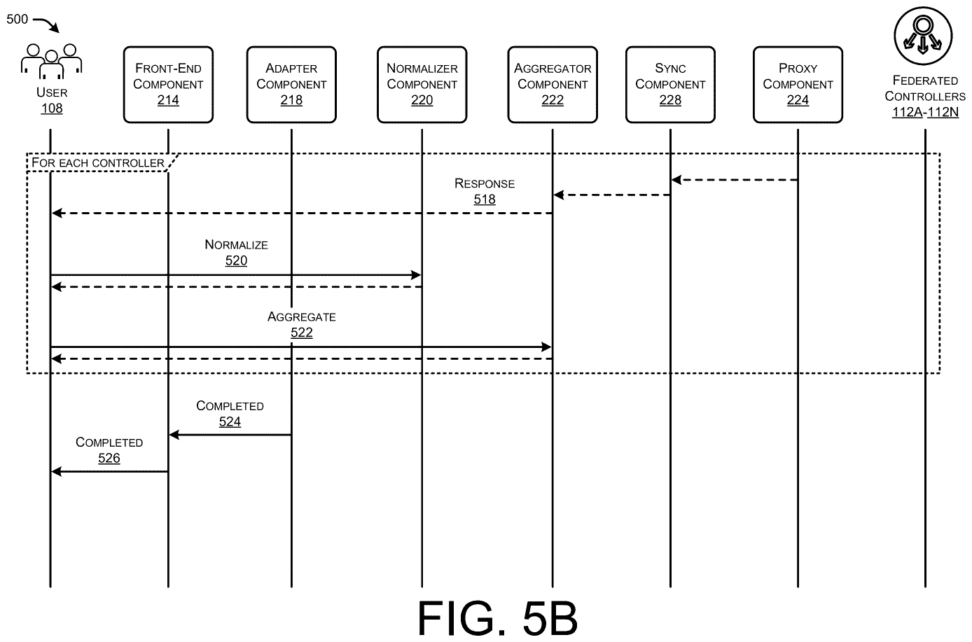

FIGS. 5A and 5B collectively illustrate a sequence diagram 500 of example communications for a centralized controller 110 to manage API communications across federated controllers 112 according to a synchronous behavior. As an option, the sequence diagram 500 may be implemented in the context of any one or more of the embodiments set forth in any previous and/or subsequent Figures and/or description thereof. Of course, however, the sequence diagram 500 may be implemented in the context of any desired environment. Further, the aforementioned definitions may equally apply to the description below.

The sequence diagram 500 depicts interactions between the users 108, the frontend component 214, the adapter component 218, the orchestration component 216, the synchronization component 226, the proxy component 224, and the federated controllers 112A-112N. The process begins when a user initiates a federation request 502 to the frontend component 214. Upon receiving this request, the frontend component 214 sends a specification request 504 to the adapter component 218 to retrieve the necessary controller specifications. The process then enters a “for each controller type” loop, where the system adapts the request for each specific controller type. During this loop, an adaptation request 510 is processed by the adapter component 218. Following the adaptation phase, the sequence enters another loop labeled “for each controller” where three successive steps occur: a controller request 512 is sent to the orchestration component 216, which forwards this as a sync request 514 to the synchronization component 226. Finally, the synchronization component 226 sends a proxy request 516 to the federated controllers 112A-112N.

The synchronous API federation process allows the centralized controller 110 to manage and coordinate API calls across multiple heterogeneous controllers in a synchronized manner. This process ensures that all API calls are properly adapted, routed, and executed across the various network domains managed by the federated controllers 112A-112N.

The adapter component 218 may utilize machine learning algorithms to optimize the adaptation process. These algorithms may analyze historical data on API call patterns and controller responses to improve the efficiency and accuracy of request adaptation over time. The synchronization component 226 may implement a timeout mechanism to handle cases where a federated controller fails to respond within a specified time frame. This mechanism may allow the system to gracefully handle slow or unresponsive controllers without impacting the overall synchronous process. In various embodiments, the proxy component 224 may incorporate load balancing capabilities to distribute API requests across multiple instances of the same controller type. This may help optimize resource utilization and improve overall system performance in large-scale deployments.

FIG. 5B illustrates a continuation of the sequence diagram 500 showing the response handling and data processing flow between various system components. As an option, the sequence diagram 500 may be implemented in the context of any one or more of the embodiments set forth in any previous and/or subsequent Figures and/or description thereof. Of course, however, the sequence diagram 500 may be implemented in the context of any desired environment.

The sequence diagram 500 in FIG. 5B depicts the response handling process, which begins with a response message 518 being returned from the federated controllers 112A-112N through the proxy component 224. For each controller response, the adapter component 218 initiates a normalize operation 520, which is processed by the normalizer component 220 to standardize the response data format.

Following normalization, an aggregate operation 522 combines the normalized data from multiple controllers into a unified dataset. The process includes completed 524 notification and completed 526 notification that flow back through the system components, ensuring that all response data is properly normalized, aggregated, and delivered to the end user in a consistent format. Steps 518-522 of the process are contained in a loop, indicating a complete processing cycle for controller responses.

The response handling process plays a crucial role in the synchronous API federation by ensuring that data from diverse controller types is properly integrated and presented to the user in a unified manner. This process allows the centralized controller 110 to provide a consistent view of the environment 100 across multiple domains and controller types.

The normalizer component 220 may support dynamic normalization rules that can be updated in real-time. This capability may allow the system to adapt to changes in controller response formats without requiring system downtime or manual intervention. The aggregator component 222 may implement advanced data fusion techniques to combine information from multiple controllers. These techniques may include statistical analysis, conflict resolution, and data quality assessment to provide the most accurate and reliable aggregated results. The frontend component 214 may offer customizable data visualization options for presenting the aggregated results. These options may include interactive charts, graphs, and tables that allow users to explore and analyze the federated API data in various ways, enhancing the overall user experience of the unified interface 124.

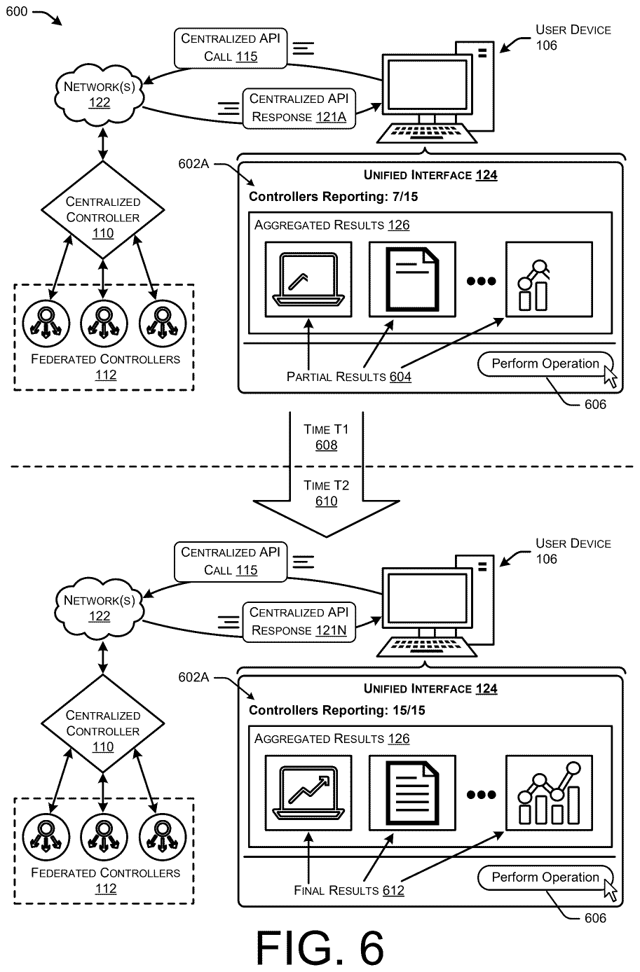

FIG. 6 illustrates an example diagram 600 of a centralized controller 110 performing progressive rendering by progressively presenting data as API communications are received from federated controllers 112. The centralized controller performs a progressive rendering process by interfacing with the federated controllers 112 and presenting results to users 108 over time, in accordance with one embodiment. The centralized API responses 121A is provided to the user device 106 with partial data collected from the federated controllers 112.

The progressive rendering sequence depicts two distinct time periods, represented by a first timestamp 608 (T1) and a second timestamp 610 (T2), demonstrating the evolution of data presentation. At the first timestamp 608, a user device 106 initiates a centralized API call 115 through the networks 122 to the centralized controller 110, which interfaces with multiple federated controllers 112. The unified interface 124 displays partial results 604 within the aggregated results 126 section, showing data from a subset of the total number of controllers reporting. A controllers reporting indicator 602A may provide information about the current status of data retrieval, such as “7 out of 15 controllers reporting.” The unified interface 124 may include various visualization elements like graphs, text, documents, or other types of the aggregated results 126, with an operation button 606 available for user interaction. As shown, the user 108 may be able to perform an operation prior to all of the data being collected from all of the federated controllers 112.

At the second timestamp 610, the progressive rendering process shows a centralized API response 121N that now reflects data from all controllers, updating the interface indicator 602A to show “15/15 controllers reporting.” The unified interface 124 displays final results 612 in the aggregated results 126 section, showing complete data visualization including updated graphs, documents, and statistical representations. The operation button 606 remains available for user interaction throughout the process.

The progressive rendering process demonstrates how the centralized controller 110 maintains functionality while progressively rendering data as it becomes available from all federated controllers 112. This approach allows users 108 to begin analyzing partial data and interacting with the centralized controller 110 and federated controllers 112 before all responses have been received, improving the overall responsiveness and user experience of the centralized controller 110.

The unified interface 124 may include dynamic updating capabilities that allow for real-time refresh of displayed information as new data is received from the federated controllers 112. This may involve using web technologies such as WebSockets or server-sent events to push updates to the user's browser without requiring page reloads. The centralized controller 110 may implement intelligent error handling and display mechanisms within the progressive rendering process. If errors are encountered when communicating with specific federated controllers 112, the unified interface 124 may highlight these errors alongside the successfully retrieved data. This may include visual indicators such as color-coding or icons to denote controllers that have failed to respond or returned error messages. The progressive rendering process may support user-configurable thresholds for data completeness. Users 108 may be able to set preferences for when the operation button 606 becomes active, based on the percentage of federated controllers 112 that have reported data. This feature may allow for flexible decision-making based on the specific needs and risk tolerance of different network management scenarios.

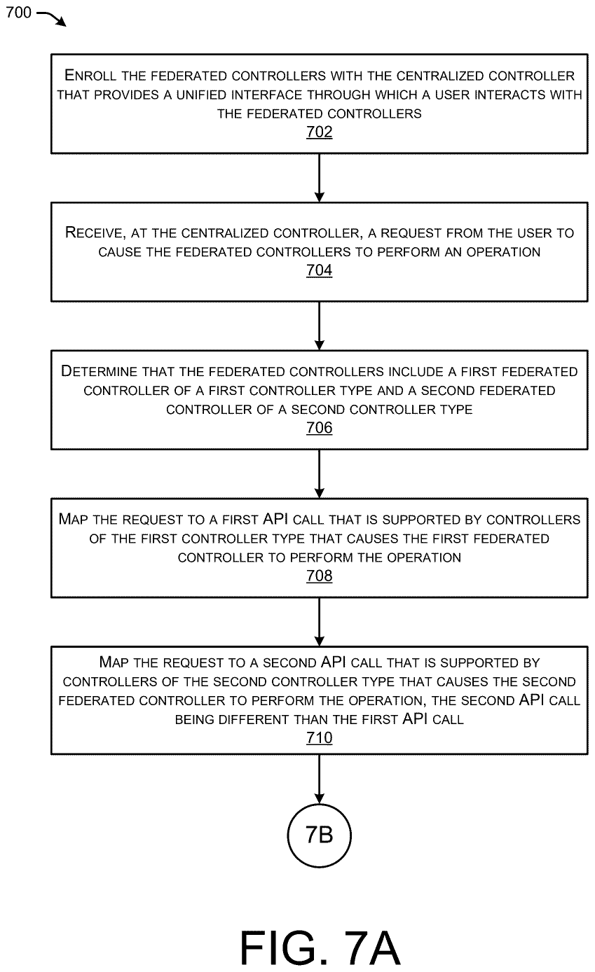

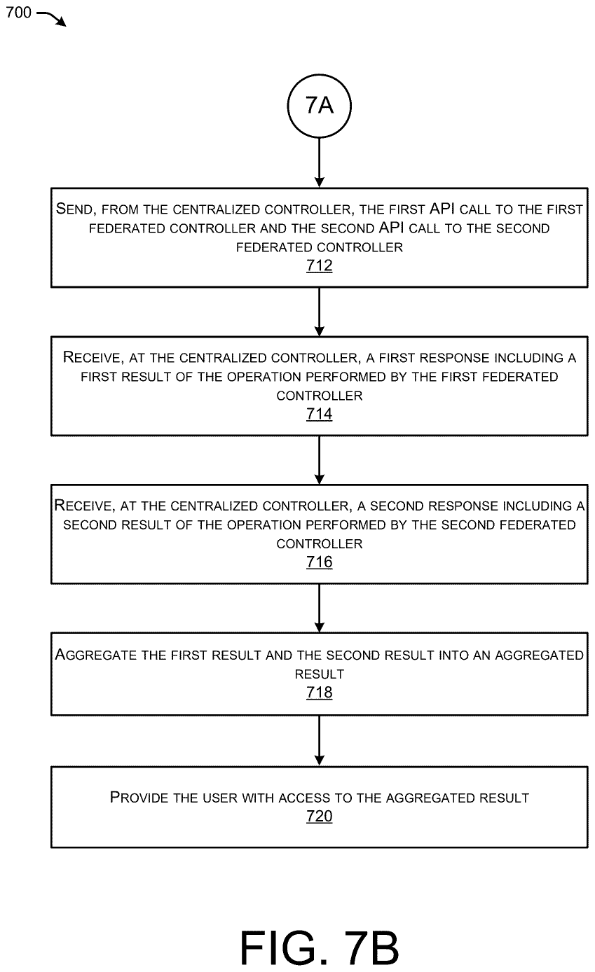

FIGS. 7A and 7B collectively illustrate a flow diagram of example method 700 that illustrates aspects of the functions performed at least partly by the devices described in FIGS. 1-6, such as the centralized controller 110, user device 106, federated controller 112, and so forth. The logical operations described herein with respect to FIGS. 7A and 7B may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 7A and 7B and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIGS. 7A and 7B collectively illustrate a flow diagram of an example method 700 for a centralized controller 110 to manage API communications across heterogeneous, federated controllers 112.

At step 702, the federated controllers 112 are enrolled with the centralized controller 110 that provides the unified interface 124 through which the users 108 interact with the federated controllers 112. The centralized controller 110 may collect and store authentication credentials for each of the federated controllers 112 in the authentication data repository. This may enable secure communication between the centralized controller 110 and the federated controllers 112.

At 704, the centralized controller 110 receives a request from the users 108 to cause the federated controllers 112 to perform an operation 118. The frontend component 214 of the centralized controller 110 may process and validate the request before passing it to the orchestration component 216 for further handling. This may include checking user permissions and ensuring the request is properly formatted.

At 706, where it is determined that the federated controllers include a first federated controller of a first controller type and a second federated controller of a second controller type. At 708, the request is mapped to a first API call that is supported by controllers of the first controller type, which causes the first federated controller to perform the operation.

At 710, the request is mapped to a second API call that is supported by controllers of the second controller type, causing the second federated controller to perform the operation, with the second API call being different than the first API call. A continuation indicator 7B indicates that the method 700 continues in a subsequent figure.

Steps 708 and 710 of mapping the request to different API calls may utilize the adapter component 218 and the endpoint specification 236 to determine the appropriate API structure for each controller type. This may allow for dynamic adaptation to new controller types or API versions without requiring changes.

The method 700 provides a systematic approach for managing heterogeneous federated controllers through the centralized controller, enabling unified control and visibility across multiple network domains. By enrolling the federated controllers and mapping user requests to appropriate API calls for each controller type, the method 700 allows for seamless interaction with diverse network architectures and controller types.

At 712, the centralized controller sends a first API call to the first federated controller and a second API call to the second federated controller. The method then proceeds to a step 714, where the centralized controller receives a first response that includes a first result of the operation performed by the first federated controller.

At 716, where the centralized controller receives a second response that includes a second result of the operation performed by the second federated controller. The method then proceeds to a step 718, where the first result and the second result are aggregated into an aggregated result.

At 720, where the users are provided with access to the aggregated result. The flowchart illustrates the sequential processing of API calls, response handling, and result aggregation performed by the centralized controller when interacting with multiple federated controllers.

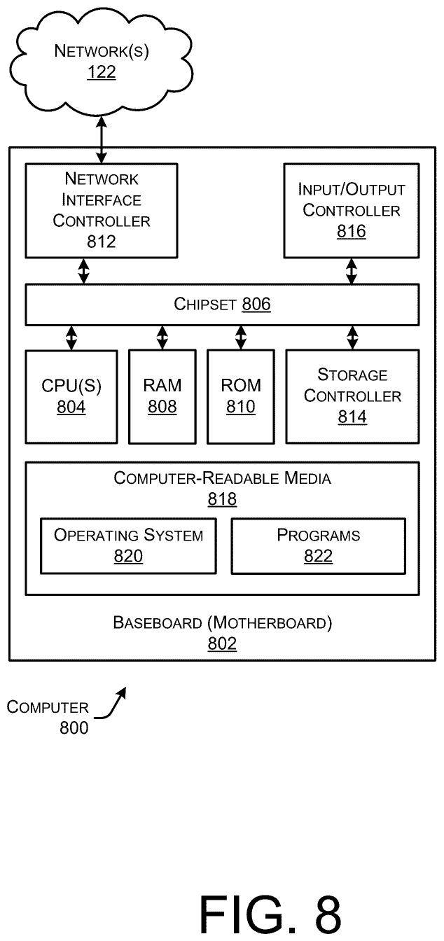

FIG. 8 shows an example computer architecture for a device capable of executing program components for implementing the functionality described above. The computer architecture shown in FIG. 8 illustrates any type of computer 800, such as a conventional server computer, workstation, desktop computer, laptop, tablet, network appliance, e-reader, smartphone, or other computing device, and can be utilized to execute any of the software components presented herein. The computer 800 may, in some examples, correspond to a centralized controller 110, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 800 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computer 800. The chipset 806 can further provide an interface to a computer-readable storage medium such as a read-only memory (“ROM”) 810 or non-volatile RAM (“NVRAM”) for storing basic routines that help to startup the computer 800 and to transfer information between the various components and devices. The ROM 810 or NVRAM can also store other software components necessary for the operation of the computer 800 in accordance with the configurations described herein.

The computer 800 can operate in a networked environment using logical connections to remote computing devices and computer systems through a network, such as the network 122. The chipset 806 can include functionality for providing network connectivity through a NIC 812, such as a gigabit Ethernet adapter. The NIC 812 is capable of connecting the computer 800 to other computing devices over the network 122. It should be appreciated that multiple NICs 812 can be present in the computer 800, connecting the computer to other types of networks and remote computer systems.

The computer 800 can be connected to a storage device 818 that provides non-volatile storage for the computer. The storage device 818 can store an operating system 820, programs 822, and data, which have been described in greater detail herein. The storage device 818 can be connected to the computer 800 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 800 can store data on the storage device 818 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 818 is characterized as primary or secondary storage, and the like.

For example, the computer 800 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 can further read information from the storage device 818 by detecting the physical states or characteristics of one or more particular locations within the physical storage units.

In addition to the mass storage device 818 described above, the computer 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 800. In some examples, the operations performed by the user device 106, the centralized controller 110, and or any components included therein, may be supported by one or more devices similar to computer 800. Stated otherwise, some or all of the operations performed by user device 106 and/or centralized controller 110, and or any components included therein, may be performed by one or more computers 800.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computer 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computer 800.

In one embodiment, the storage device 818 or other computer-readable storage media is encoded with computer-executable instructions which, when loaded into the computer 800, transform the computer from a general-purpose computing system into a special-purpose computer capable of implementing the embodiments described herein. These computer-executable instructions transform the computer 800 by specifying how the CPUs 804 transition between states, as described above. According to one embodiment, the computer 800 has access to computer-readable storage media storing computer-executable instructions which, when executed by the computer 800, perform the various processes described above with regard to FIGS. 1-7B. The computer 800 can also include computer-readable storage media having instructions stored thereupon for performing any of the other computer-implemented operations described herein.

The computer 800 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computer 800 might not include all of the components shown in FIGS. 2 and/or 3, can include other components that are not explicitly shown in FIG. 8, or might utilize an architecture completely different than that shown in FIG. 8.

As described herein, the computer 800 may comprise one or more of a user device 106, a centralized controller 110, and/or any other device. The computer 800 may include one or more hardware processors 804 (processors) configured to execute one or more stored instructions. The processor(s) 804 may comprise one or more cores. Further, the computer 800 may include one or more network interfaces configured to provide communications between the computer 800 and other devices, such as the communications described herein as being performed by the user device 106 or centralized controller 110. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for a centralized controller that federates Application Programming Interface (API) communications with federated controllers, the method comprising:
enrolling the federated controllers with the centralized controller that provides a unified interface through which a user interacts with the federated controllers;
receiving, at the centralized controller, a request from the user to cause the federated controllers to perform an operation;
determining that the federated controllers include a first federated controller of a first controller type and a second federated controller of a second controller type;
mapping the request to a first API call that is supported by controllers of the first controller type that causes the first federated controller to perform the operation;
mapping the request to a second API call that is supported by controllers of the second controller type that causes the second federated controller to perform the operation, the second API call being different than the first API call;
sending, from the centralized controller, the first API call to the first federated controller and the second API call to the second federated controller;
receiving, at the centralized controller, a first response including a first result of the operation performed by the first federated controller;
receiving, at the centralized controller, a second response including a second result of the operation performed by the second federated controller;
aggregating the first result and the second result into an aggregated result; and
providing the user with access to the aggregated result.

2. The method of claim 1, further comprising:
determining that the first result comprises first data that is in a first data format;
determining that the second result comprises second data that is in a second data format; and
converting at least one of the first data or the second data such that the first data and second data are in a same format,
aggregating the first response and the second response is performed subsequent to the converting such that the aggregated result is in the same format.

3. The method of claim 2, further comprising:
obtaining an endpoint specification that maps centralized controller APIs to federated controller APIs; and
determining, using the endpoint specification, that the first data generated by the first federated controller and the second data generated by the second federated controller are to be converted into a format type of the same format.

4. The method of claim 1, further comprising:
obtaining an endpoint specification that maps centralized controller APIs to federated controller APIs;
identifying, in the endpoint specification, a first mapping between the request and the first API call; and
identifying, in the endpoint specification, a second mapping between the request and the second API call.

5. The method of claim 1, further comprising:
receiving, at the centralized controller, an indication that responses from the federated controllers be provided to the user in an asynchronous matter such that the user is able to access the responses as they are received,
wherein the aggregated result comprises less than all of the responses from the federated controllers;
sending, from the centralized controller, a third API call to a third federated controller;
receiving, at the centralized controller, a third response including a third result of the operation performed by the third federated controller;
subsequent to providing the user with access to the aggregated result:
aggregating the first result, the second result, and the third result into a second aggregated result; and
providing the user with access to the second aggregated result.

6. The method of claim 1, further comprising:
receiving, at the centralized controller, an indication that responses from the federated controllers be provided to the user in a synchronous matter such that the user is able to access the aggregated result after all responses received from the federated controllers; and
determining that all the responses have been received from the federated controllers,
wherein the responses are aggregated into the aggregated result and the user is provided access to the aggregated result based at least in part on determining that all of the responses have been received from the federated controllers.

7. The method of claim 5, wherein:
the first API call and the second API call are legacy API calls such that the centralized controller communicates with the first federated controller and the second federated controller without requiring changes to API calls of the first federated controller and the second federated controller; and
the first response and second response are legacy API responses such that the centralized controller receives data form the first federated controller and the second federated controller without requiring changes to API responses of the first federated controller and the second federated controller.

8. A system that supports a centralized controller that federates Application Programming Interface (API) communications with federated controllers, the system comprising:
one or more processors; and
one or more non-transitory computer-readable media storing computer-executable instructions that, when executed by the one or more processors, cause the centralized controller to perform operations comprising:
enrolling the federated controllers with the centralized controller that provides a unified interface through which a user interacts with the federated controllers;
receiving, at the centralized controller, a request from the user to cause the federated controllers to perform an operation;
determining that the federated controllers include a first federated controller of a first controller type and a second federated controller of a second controller type;
mapping the request to a first API call that is supported by controllers of the first controller type that causes the first federated controller to perform the operation;
mapping the request to a second API call that is supported by controllers of the second controller type that causes the second federated controller to perform the operation, the second API call being different than the first API call;
sending, from the centralized controller, the first API call to the first federated controller and the second API call to the second federated controller;
receiving, at the centralized controller, a first response including a first result of the operation performed by the first federated controller;
receiving, at the centralized controller, a second response including a second result of the operation performed by the second federated controller;
aggregating the first result and the second result into an aggregated result; and
providing the user with access to the aggregated result.

9. The system of claim 8, the operations further comprising:
determining that the first result comprises first data that is in a first data format;
determining that the second result comprises second data that is in a second data format; and
converting at least one of the first data or the second data such that the first data and second data are in a same format,
aggregating the first response and the second response is performed subsequent to the converting such that the aggregated result is in the same format.

10. The system of claim 9, the operations further comprising:
obtaining an endpoint specification that maps centralized controller APIs to federated controller APIs; and
determining, using the endpoint specification, that the first data generated by the first federated controller and the second data generated by the second federated controller are to be converted into a format type of the same format.

11. The system of claim 8, the operations further comprising:
obtaining an endpoint specification that maps centralized controller APIs to federated controller APIs;
identifying, in the endpoint specification, a first mapping between the request and the first API call; and
identifying, in the endpoint specification, a second mapping between the request and the second API call.

12. The system of claim 8, the operations further comprising:
receiving, at the centralized controller, an indication that responses from the federated controllers be provided to the user in an asynchronous matter such that the user is able to access the responses as they are received,
wherein the aggregated result comprises less than all of the responses from the federated controllers;
sending, from the centralized controller, a third API call to a third federated controller;
receiving, at the centralized controller, a third response including a third result of the operation performed by the third federated controller;
subsequent to providing the user with access to the aggregated result:
aggregating the first result, the second result, and the third result into a second aggregated result; and
providing the user with access to the second aggregated result.

13. The system of claim 8, the operations further comprising:
receiving, at the centralized controller, an indication that responses from the federated controllers be provided to the user in a synchronous matter such that the user is able to access the aggregated result after all responses received from the federated controllers; and
determining that all the responses have been received from the federated controllers,
wherein the responses are aggregated into the aggregated result and the user is provided access to the aggregated result based at least in part on determining that all of the responses have been received from the federated controllers.

14. The system of claim 8, wherein:
the first API call and the second API call are legacy API calls such that the centralized controller communicates with the first federated controller and the second federated controller without requiring changes to API calls of the first federated controller and the second federated controller; and
the first response and second response are legacy API responses such that the centralized controller receives data form the first federated controller and the second federated controller without requiring changes to API responses of the first federated controller and the second federated controller.

15. A computing device that supports a centralized controller that federates Application Programming Interface (API) communications with federated controllers, the computing device comprising:
one or more processors; and
one or more non-transitory computer-readable media storing computer-executable instructions that, when executed by the one or more processors, cause the centralized controller to perform operations comprising:
enrolling the federated controllers with the centralized controller that provides a unified interface through which a user interacts with the federated controllers;
receiving, at the centralized controller, a request from the user to cause the federated controllers to perform an operation;
determining that the federated controllers include a first federated controller of a first controller type and a second federated controller of a second controller type;
sending, from the centralized controller, a first API call to the first federated controller, the first API call being supported by the first controller type and causing the first federated controller to perform the operation;
sending, from the centralized controller, a second API call to the second federated controller, the second API call being supported by the second controller type and causing the second federated controller to perform the operation;
receiving, at the centralized controller, a first response including a first result of the operation performed by the first federated controller;
receiving, at the centralized controller, a second response including a second result of the operation performed by the second federated controller;
aggregating the first result and the second result into an aggregated result; and
providing the user with access to the aggregated result.

16. The computing device of claim 15, the operations further comprising:
determining that the first result comprises first data that is in a first data format;
determining that the second result comprises second data that is in a second data format; and
converting at least one of the first data or the second data such that the first data and second data are in a same format,
aggregating the first response and the second response is performed subsequent to the converting such that the aggregated result is in the same format.

17. The computing device of claim 16, the operations further comprising:
obtaining an endpoint specification that maps centralized controller APIs to federated controller APIs; and
determining, using the endpoint specification, that the first data generated by the first federated controller and the second data generated by the second federated controller are to be converted into a format type of the same format.

18. The computing device of claim 15 the operations further comprising:
obtaining an endpoint specification that maps centralized controller APIs to federated controller APIs;
identifying, in the endpoint specification, a first mapping between the request and the first API call; and
identifying, in the endpoint specification, a second mapping between the request and the second API call.

19. The computing device of claim 15, the operations further comprising:
receiving, at the centralized controller, an indication that responses from the federated controllers be provided to the user in an asynchronous matter such that the user is able to access the responses as they are received,
wherein the aggregated result comprises less than all of the responses from the federated controllers;
sending, from the centralized controller, a third API call to a third federated controller;
receiving, at the centralized controller, a third response including a third result of the operation performed by the third federated controller;
subsequent to providing the user with access to the aggregated result:
aggregating the first result, the second result, and the third result into a second aggregated result; and
providing the user with access to the second aggregated result.

20. The computing device of claim 15, the operations further comprising:
receiving, at the centralized controller, an indication that responses from the federated controllers be provided to the user in a synchronous matter such that the user is able to access the aggregated result after all responses received from the federated controllers; and
determining that all the responses have been received from the federated controllers,
wherein the responses are aggregated into the aggregated result and the user is provided access to the aggregated result based at least in part on determining that all of the responses have been received from the federated controllers.
